(19) United States
(12) Patent Application Publication
(10) Pub. No.: US 2014/0088946 A1
(43) Pub. Date: Mar. 27, 2014

(54) Method for simulating a control device

(71) Applicants: Michael SCHUMPELT, Oberriexingen (DE); Hartmut Baessler, Berglen (DE); Patrick Denu, Schorndorf (DE); Herbert Leuwer, Backnang (DE); Rainer Kaiser, Heilbronn (DE)

(72) Inventors: Michael SCHUMPELT, Oberriexingen (DE); Hartmut Baessler, Berglen (DE); Patrick Denu, Schorndorf (DE); Herbert Leuwer, Backnang (DE); Rainer Kaiser, Heilbronn (DE)

(73) Assignee: Robert Bosch GmbH, Stuttgart (DE)

(21) Appl. No.: 14/034,766

(22) Filed: Sep. 24, 2013

(30) Foreign Application Priority Data
Sep. 25, 2012 (DE) 10 2012 217 328.5

(51) Int. Cl. G05B 17/02

(52) U.S. Cl. CPC G05B 17/02
USPC 703/13

(57) ABSTRACT

A method is provided for simulating a control device, on which a software is executed, on a computer platform having a hardware which is to be actuated via hardware drivers, the hardware drivers being connected via an interface to the software of the control device, the method including: in a first step, the hardware is recognized; and in a subsequent step, a microcontroller abstraction layer is generated on the computer platform, in which the interface is customized to the hardware drivers present; at least one plugin being produced for at least one hardware driver.

### BACKGROUND OF THE INVENTION

1. Field of the Invention

The present invention relates to a method for simulating a control device and a system for carrying out the method.

2. Description of the Related Art

Control devices which are used, for example, in motor vehicles for controlling and regulating different components and sequences, are electronic modules which record variables detected by sensors, evaluate them and, based on this evaluation, emit signals for the control and regulation to further components, such as actuators.

In motor vehicles, control devices (ECU: electronic computing units) communicate via different system buses, data concerning operating states and additional relevant data being exchanged in the motor vehicle. In the process, a so-called on-board diagnosis (OBD) may also be carried out.

The software present in control devices may be subdivided into so-called infrastructure software which takes over basic functions and usually includes the operating system and software components for communications, such as the application software which includes the desired functionality.

The development of the software and the hardware of a control device may take place in parallel. Therefore it may happen that software has to be tested within the scope of the development process, although the real control device, or rather its hardware, is not yet available. However, for the testing it is necessary to be able to carry out a simulation of the software. For this case, it is known that one may carry out a simulation of the control device on a PC platform.

Published European patent application document EP 2 172 857 A1 describes a Rapid Prototyping System which includes an application kernel and a simulation kernel. In it, a so-called control bank is carried out by the application kernel, which receives user commands and generates control signals for a simulation program. It is provided, in this instance, that functions of a control system using the simulation program are simulated, this control system also being able to be developed as a control device.

Published German patent application document DE 10 2005 044 236 A1 describes a diagnostic device which is used for the simulation of at least one control device, which is relevant for an on-board diagnosis (OBD). Using the diagnostic device, a communication between the at least one control device and the at least one reading tool may be checked. In the simulation of the at least one control device, error simulations may also be incorporated.

Furthermore, a standard is known that is designated as AUTOSAR (AUTmotive Open System ARchitecture), which describes an infrastructure, using which software producers are able to install software for simulating on any desired platform. AUTOSAR is a development partnership made up of automobile manufacturers, control device producers and providers of development tools, control device basic software and microcontrollers. The aim is to simplify the exchange of software on various control devices. For this purpose, a uniform software architecture was worked out having uniform description and configuration formats for embedded software in automobiles. AUTOSAR defines methods for describing software in the vehicle, which ensure that software components are able to be reused, exchanged, scaled and integrated. A PC (personal computer) is regularly used as the simulation platform.

The AUTOSAR validation platform (VAP) simulates electronic control devices (ECU) on a standard PC computer platform. The ECU hardware is abstracted towards higher software layers by the ECU hardware and the corresponding drivers in the AUTOSAR basic software are replaced by VAP-specific hardware drivers. The driver modules control either physical hardware functions using physical units or they simulate hardware functions using simulated units.

An ECU abstracted in such a way and simulated is designated as a virtual ECU or just a VECU. By the instantiation of a plurality of VECU's on a single efficient computer platform using a plurality of CPU's, the so-called VAP target, the VAP is in a position to take up a network of an almost unlimited number of VECU's. Emulated ECU's use physical units and are capable in real time, if the resources of the VAP target are correctly assigned to the VECU-AUTOSAR software. Simulated ECU's use simulated units and enable each VECU to utilize all resources of the CPU.

The operating cycle of AUTOSAR-conforming ECU software includes four main phases:
Authorization Phase: In this phase, the user installs a configuration data bank that conforms to AUTOSAR, using suitable configuration editors.
Source Code Generation Phase: In this phase, the configuration data bank is used to generate the configuration source and the header data files.
Forming Phase: In this phase, the application software components, hardware-independent BSW software components (BSW: control device software), hardware-dependent software components (drivers) and the generated configuration source and header data files are compiled and linked to libraries, so as to be executable in the ECU.
Runtime Phase: In this phase, the executable ECU is started and operated. In connection with VAP, experiments are carried out in the runtime phase.

An executable standard ECU is statically connected and includes the required hardware driver modules. Variations for experimental setups, such as an exchange of hardware implementations, exchange of physical units with simulated units and vice versa, require the renewed forming of the statically connected, executable ECU. The original ECU configuration provided to the customer has to be changed. The complete operating cycle of the authorization phase up to the runtime phase must be repeated.

There are various disadvantages in such a precompiled time configuration in connection with the AUTOSAR validation platform:

The ECU configuration data bank of the customer has to be customized and changed.

The VECU software has to be redesigned during the authorization, the code generation and the formation phase if the runtime configuration is changed. This redesign requires an extensive knowledge of AUTOSAR. Furthermore, this represents a task that is both time-consuming and error-prone.

VAP-specific runtime configurations are not covered by AUTOSAR standard tools.

The authorization phase and the runtime phase are connected to each other, which only conditionally fits the working runs of the customers. Thus, the separate licensing of authorization tools and runtime tools is not possible.

### BRIEF SUMMARY OF THE INVENTION

In the method proposed for the abstraction of a hardware of a control device based on AUTOSAR, a design is provided to undertake a configuration during a loading time as well as to design a plugin for a driver. In this context, based on configuration data files of a real control device a virtual control device is provided.

At the loading time, a configuration of the virtual control device may be executed. The loading time is the time period which lies before the actual program run, the simulation using VECU, and in which configurations are able to be undertaken.

Consequently, the method introduced provides a so-called configuration for the loading time of virtual ECU's in connection with a plugin driver concept for unit drivers. The loading time configuration is advantageous. Thus, the ECU configuration of the customer does not have to be changed if a VECU to VAP or back to the original hardware is ported. The loading time configuration and parameters are able to be changed or set without the software having to be redesigned. The authorization phase and the runtime phase are strictly decoupled. The authorization tool chain is not necessarily required in the case of all experimental environments, which fits the working sequence of the customer better and makes licensing easier.

Since the configuration takes place after the VECU software has been loaded into the memory of the VAP target, deeper runtime configuration changes and variations are possible. Furthermore, product-internal hardware variations are hidden from the ECU software configuration.

The loading time configuration provided represents a flexible method for setting up experimental environments for an ECU software validation, without having to change the AUTOSAR configuration which matches the standard of the customer.

Basically, in a first step, the hardware on which the simulation is executed is recognized. This may mean that this is disclosed to the system or the VAP. In a next step, a microcontroller abstraction layer is generated in which the interface, via which the hardware drivers are connected to the software, is customized.

Additional advantages and developments of the present invention result from the specification and the appended figures.

It is understood that the features mentioned above and still to be explained below may be used not only in the indicated combinations, but in other combinations as well, or by themselves, without departing from the scope of the present invention.

### BRIEF DESCRIPTION OF THE DRAWINGS

FIG. 1 shows an embodiment of the method described.

FIG. 2 shows a state diagram of a VECU.

FIG. 3 shows an example of a framework of a runtime configuration and of a driver plugin.

### DETAILED DESCRIPTION OF THE INVENTION

The present invention is represented schematically in the drawings with the aid of specific embodiments, and described in detail below with reference to the drawings.

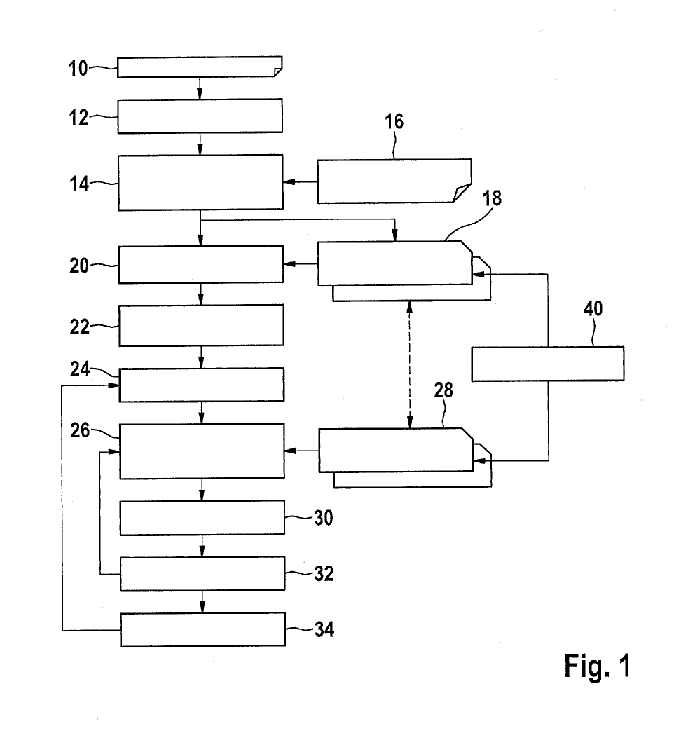

FIG. 1 describes a possible execution of the method provided in a flow chart, a so-called configuration flow. In a first step 10, the ECU configuration data files are present. In a subsequent step 12, the ECU configuration is customized. In a step 14, the modified code for drivers is subsequently generated. For this purpose, driver configuration VAP 16 is used. The modified code is input into VAP driver proxies 18. In those, there takes place a translation of symbols to form a branch table. These driver proxies 18 are used in order to form an executable version of the VECU, in a next step 20. This VECU is used in a next step 22 to download the executable version of the VECU to the VAP target. This loaded VECU is executed in a next step 24.

Subsequently, in a step 26, the ECU is configured, and for this, plugins are loaded, plugins are initialized and branch tables are filled out. The entry points of software functions are stored in branch tables.

For this, VAP driver plugins 28 are used. In parallel to this (step 40) the development of the plugins takes place. Then, in a step 30, there takes place the starting of the executable version of the VECU, and subsequently (step 32) stopping of the executable version and finally (step 34) unloading of the executable version.

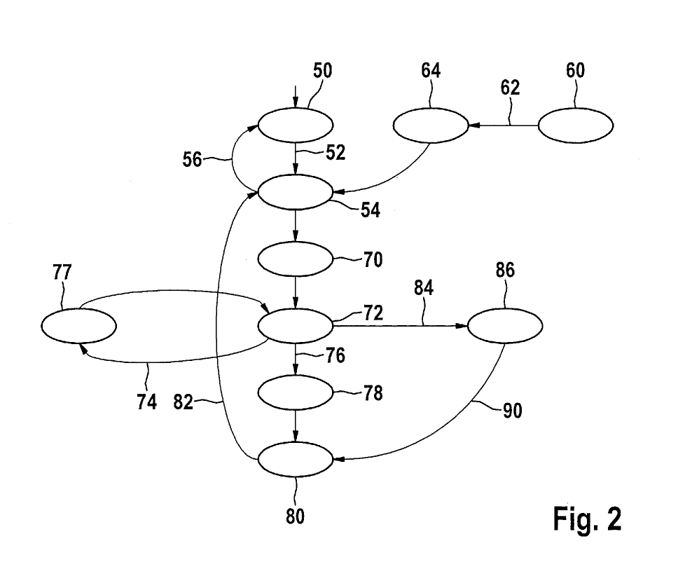

In FIG. 2, in a state diagram, states of a VECU are reflected. A first state 50 UNLOAD is assumed after starting. By loading the VECU into the VAP target control (arrow 52), state 54 LOADED is assumed. If the VECU is unloaded again (arrow 56), a return to state 50 takes place.

Starting from any state 60, in the case of an error (arrow 62), state 64 ERROR may be assumed. If, starting from this, VAP target control is loading the VECU, state 54 LOADED is assumed. Starting from this state 54, when the VECU is started or an autostart takes place, state 70 STARTUP is assumed in which old plugins are unloaded, new plugins are loaded and the collected configuration is used.

In the next state 72 EXECUTE, the VECU is brought to execution. Starting from this state 72, if the VECU control requires a pause (arrow 74), the assuming of state 77 PAUSE takes place. If a restart is requested, state 72 is assumed again.

Starting from state 72, if the VECU control requests it (arrow 76) state 78 TERMINATED is assumed. Subsequently, state 80 SHUT DOWN is assumed. Starting from state 80, if the VECU is loaded again (arrow 82), state 54 is assumed. Starting from state 72, if an error is discovered (arrow 84) state 86 ERROR is assumed. Starting from this state 86, if the VECU is started anew or it is stopped (arrow 90), a transition to state 80 takes place.

Consequently, FIG. 1 shows an overview of the general configuration flow and FIG. 2 shows the associated states of the VECU. As soon as the VECU has been loaded, which corresponds to state 54, it is in the memory of the CPU and there is complete access to the entire memory and the peripheral hardware. However, the VECU AUTOSAR software is not running yet.

Data are collected during the runtime configuration in state 54 LOADED. This collection during the runtime configuration is carried out either interactively, the VAP control tool being used, or automatically by a previously defined runtime configuration data bank. The VECU enters state 70 STARTUP when the user requests it, or automatically when the collection for the runtime configuration is terminated. In state 70 STARTUP, device driver plugins are loaded, the dynamic connection systems of the operating system lying below them being used.

After the driver plugins have been loaded, the previously collected configuration is executed. During the execution of the runtime configurations, the driver plugins are initialized and the VECU software is parameterized. The VECU software is now in a position completely to abstract the ECU hardware and it starts. The VECU is now in state 72 EXECUTE.

By a plugin one should understand an extension module which represents a software module which is able to be discovered and attached by a software application during its runtime in order to extend its functionality.

During the state EXECUTE, the runtime configuration collection of the VECU and the driver plugins must not change. The driver plugins may not be unloaded in the state of EXECUTE. It is, however, still possible to control the VECU and to change specific runtime parameters for experimental purposes.

The reconfiguration and the exchange of driver plugins, such as the exchange of simulated devices by physical devices, require the shutting down of the running VECU software. After the VECU has terminated the operation, the latter enters into state 80 SHUTTING DOWN, while the driver plugins are preparing themselves to be unloaded or loaded anew, by releasing all associated system resources. The VECU may then assume state 52 LOADED again and the driver plugins are able to be reconfigured or even exchanged.

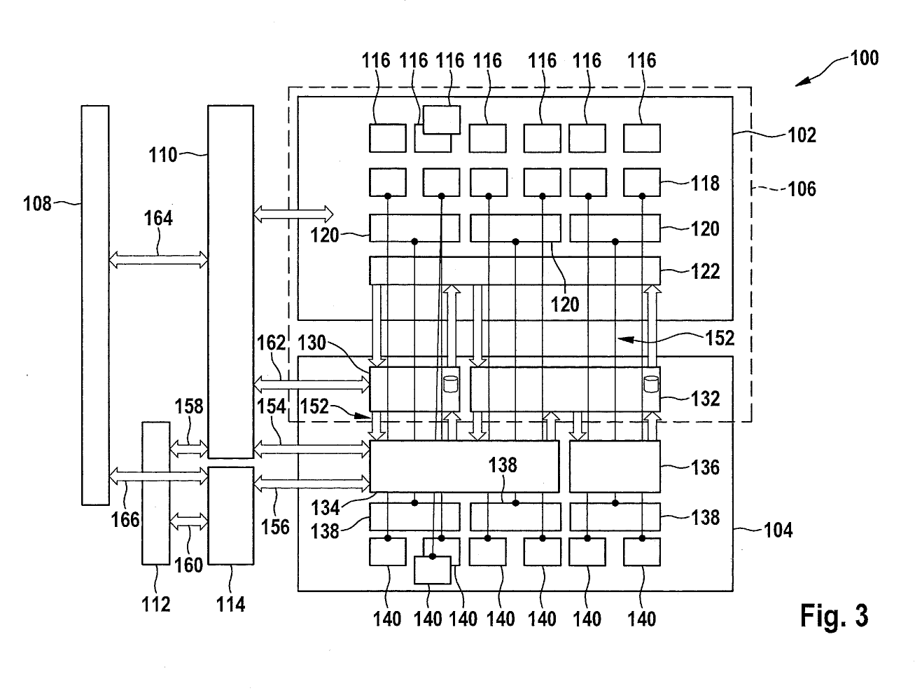

FIG. 3 shows a framework for the loading time configuration and the driver plugin, which altogether is designated by reference numeral 100. Consequently, the logical construction of a software is shown, using CAN as the example, which is executed on a VAP target. The VAP target is a PC, for example. The representation shows a hardware-independent VECU software 102, which represents the AUTOSAR range, and the hardware and software structure 104 on the PC platform. An executable version 106 of the static VECU is clarified by being bordered all around.

Furthermore, a VAP control 108, a VECU manager 110, a PC 112, on which the application is executed and a VAP hardware manager 114 are shown.

In VECU software 102, the identifiers of the protocol data unit (protocol data unit ID) 116, hardware object handles 118, controllers 120 and a CAN interface 122 are provided. A hardware object handle represents an abstract reference to a CAN mailbox structure, which includes CAN-referenced parameters.

In hardware and software structure 104, a first proxy 130 for a drive A and a second driver B are provided. Furthermore, a plugin X 134, a plugin Y 134, which represent links to real drivers, CAN nodes 138 and a number of buffers 140 are provided

Furthermore, a series of interfaces is shown, namely, an AUTOSAR-API 150 having a name convention, an AUTOSAR-API 152 without a name convention, a plugin-API 154, a platform API 156, a Linux library API 158 for a dynamic loading, an API 160 for RTPC services, an interface 162 for controlling or monitoring the VECU software for the runtime, a VECU control interface 164 and a VAP target control interface 166. API (application programming interface) here stands for an interface for application programming.

Framework 100 shown in exemplary fashion in FIG. 3 is made up of the following functional components:

driver configuration before compilation,
VECU manager,
VECU software,
device driver proxy module,
device driver plugin module,
plugin loading unit,
configuration collection,
configuration execution.

The AUTOSAR software creation process is based on a statically connected executable version of the VECU, modules in the ECU abstraction layer differentiating between driver module implementation for various underlying hardware by name convention. All global symbols, such as functions and variables, the API (application programming interface), which are exported by a driver software module, are extended in that seller-specific data are used.

These implementation-specific symbol references may be fulfilled by generic implementation-independent, dynamic libraries used in common, which have to fit each ECU implementation.

Each statistically executable version of the VECU conforming to AUTOSAR requires a configuration of the driver parameters conforming to AUTOSAR, which are typically placed in the ECU ROM. Only the content and the C-typename of the configuration structure are standardized. The internal structure of the configuration data set is specific and transparent for higher software layers. The latter makes it possible for drivers to link in seller-specific parameters, which are not visible for the standard AUTOSAR functions. The plugin concept uses this design approach, in that it makes available its own internal VAP-specific structure. This structure replaces customer structures in the same way that proxydriver modules replace customer driver modules. VAP-specific driver configurations understood by driver plugin modules are easily able to be linked in at this point. It is recommended that the configuration be positioned in memory locations having loading time write access. These configuration structures are produced together with the proxydriver module code generation.

The VECU manager is the main execution string of a VECU process. This runs when the VECU is loaded. The VECU manager is used for the VAP control interface and has access to the data system of the computer. The latter collects the VECU loading time configuration, loads device driver plugin modules and executes the VECU loading time configuration. The latter also controls the VECU software and monitors its status during the runtime.

The VECU software includes all AUTOSAR-defined software components, such as application code, real time operating system and basic software modules.

The device driver proxymodules are used as a customizing layer or adaptation layer between the statically connected executable version of the VECU and the dynamically loaded device driver plugin modules. A device driver proxy carries out the following specific tasks:

Providing the API conforming to AUTOSAR,

Translating the name-based driver implementation differentiation into address-based driver implementation differentiation, indexed branch tables being used which resolve the symbol addresses rather during the loading time than during the generation time.

Since the device driver proxymodules have to present AUTOSAR configuration-specific symbol names, the latter are generated automatically during the AUTOSAR authorization phase. For each customer-defined hardware driver a proxymodule is produced, the seller ID being taken from the customer-produced AUTOSAR configuration data bank. The code generation for device driver proxymodules is simple, since the internal functions of the proxydriver modules have to provide AUTOSAR standard signatures and only address translations and invoke a forward functionality.

The device driver plugin modules include the actual device functions without name extension. There is a device driver plugin module for each VAP hardware or each simulated device type. The device driver plugin modules provide a plugin API having the following services:

### Receive Symbol References

The plugin modules deliver a driver-specific set of runtime references, which are used by the framework of the loading time configuration, in order to fill the branch tables of the device driver proxymodules.

### Set Symbol References

The plugin modules provide a branch table in order to recall functions in the device driver proxymodules. The device driver proxymodule-specific recall functions references are inserted into these branch tables.

### Initialization

The plugin modules are initialized. It should be noted that this is not the AUTOSAR-ECU software initialization of the driver functionality. The latter is part of the service that is provided by the plugin module.

### Deinitialization

The plugin modules release all allocated resources and are prepared to be unloaded from the memory.

The configuration collection is a service that is provided by the VECU outside of AUTOSAR. This is made up of a set of data structures which are used during the initialization of the device driver plugin modules. These data structures include the following loading time configuration information:
device driver plugin selection,
plugin-specific device drivers, not AUTOSAR parameters,
runtime values for AUTOSAR parameters.

Thus, the configuration collection provides means for receiving this loading time configuration information from the VAP control interface or from the configuration data files.

The plugin module loading unit is a generic service that is provided by the VECU outside of the AUTOSAR software. It uses the configuration collection in order to load the selected driver plugins.

The configuration execution is a service that is provided by the VECU outside of the AUTOSAR software. It executes the following functions:
initializing the loaded device driver plugins, the configuration collection-specific non-AUTOSAR parameters being used,
parameterizing the VECU, the configuration collection runtime values for AUTOSAR parameters being used.

The AUTOSAR software generating process is based on a statically connected VECU, which is executable, modules in the ECU abstraction layer being distinguished between driver modules and other modules.

What is claimed is:

1. A method for simulating at least one control device, on which a software is executed, on a computer platform having a hardware, wherein the computer platform is to be actuated via hardware drivers, the hardware drivers being connected via an interface to the software of the control device, the method comprising:
recognizing, in a first step, the hardware of the computer platform; and
generating, in a subsequent step, a microcontroller abstraction layer on the computer platform, in which the interface is customized to the hardware drivers present;
wherein at least one plugin is produced for at least one hardware driver.

2. The method as recited in claim 1, wherein the method is carried out using an AUTOSAR validation standard.

3. The method as recited in claim 2, wherein a personal computer is used as the computer platform.

4. The method as recited in claim 3, wherein a configuration is carried out during a loading time.

5. The method as recited in claim 3, wherein multiple control devices are simulated on the computer platform.

6. The method as recited in claim 3, wherein device driver proxy modules are used.

7. The method as recited in claim 3, wherein device driver plug-in modules are used.

8. A system for simulating a control device, on which a software is executed, comprising:
a computer platform having a hardware, wherein the computer platform is to be actuated via hardware drivers, the hardware drivers being connected via an interface to the software of the control device;
wherein, for the simulation, the system is configured to perform the following:
recognize, in a first step, the hardware of the computer platform; and
generate, in a subsequent step, a microcontroller abstraction layer on the computer platform, in which the interface is customized to the hardware drivers present;
wherein at least one plugin is produced for at least one hardware driver.

9. The system as recited in claim 8, wherein a personal computer is used as the computer platform.
